(19) United States
(12) Patent Application Publication
(10) Pub. No.: US 2025/0231145 A1
(43) Pub. Date: Jul. 17, 2025

(54) DELIVERY TUBING ADAPTER FOR EDDY CURRENT PROBES

(71) Applicant: Zetec, Inc., Snoqualmie, WA (US)

(72) Inventors: Wayne Rector, Bellevue, WA (US); Ammon Keller, North Bend, WA (US); Paubla M. Tarango, Renton, WA (US); Charles Gary, Covington, WA (US); William Frederick Ziegenhagen, Black Diamond, WA (US)

(21) Appl. No.: 19/015,195

(22) Filed: Jan. 9, 2025

Related U.S. Application Data
(60) Provisional application No. 63/620,426, filed on Jan. 12, 2024.

(51) Int. Cl. G01N 27/9093; G01N 27/90

(52) U.S. Cl. CPC G01N 27/9093; G01N 27/9006

(57) ABSTRACT

An adapter for securely engaging an eddy current probe shaft to a length of delivery tubing includes a tubular body having a probe shaft engaging portion and a delivery tubing engaging portion. The probe shaft engaging portion is sized for receipt within a central aperture of the delivery tubing and the probe shaft engaging portion comprises at least a barbed portion and a threaded portion for frictionally engaging an inside surface of the delivery tubing.

### CROSS-REFERENCE TO RELATED APPLICATION

This application claims priority under 35 U.S.C. § 119, based on U.S. Provisional Patent Application No. 63/620,426 filed Jan. 12, 2024, titled “Delivery Tubing Adapter for Eddy Current Probes,” the disclosure of which is hereby incorporated by reference.

### BACKGROUND

Steam generation for driving turbines has been an aspect of electrical power generation for many decades. Routine monitoring of the condition of high-pressure steam tubes in steam generators is critical. Steam tube inspection is generally conducted with cylindrically shaped eddy current probes that are inserted into steam tube arrays. The eddy current probe travels through the arrays/tubes and emits eddy currents onto surfaces of the tubes. The tubes are attached to cabling while monitoring equipment records the eddy current response as the probe travels through the tubes.

Eddy current probes operate by using coils alternating an electromagnet field onto a conduit as it travels within the conduit and receiving electromagnetic returns via the conduit. The electromagnetic field produces eddy currents in the tubes, which can be measured either by a change in impedance of the excitation coil or by separate coils, hall-effect sensors or magneto-resistive sensors. In interacting with the conduit structure, the probe is able to locate defects by recognizing anomalies, such as disbonds, bubbles, cracks, corrosion, delaminations, thickness variation, and the like.

Typical eddy current probes for non-destructive testing of heat exchanger tubing and the like are composed of a probe head supporting a plurality of sensing coils and a flexible nylon delivery tubing which is used to push/pull the probe head into or out of the tubing or conduit under test, typically using a motorized tube or conduit pushing/pulling device. Wiring for the probe head is carried within the delivery tubing and a connector is typically provided for enabling a removable connection to testing equipment.

In some implementations, the probe head may be joined to the delivery tubing via an adapter interface component. Known adapter interface components may include lengthy, rigid components which may limit the flexibility of the resulting assembly.

### BRIEF DESCRIPTION OF THE DRAWINGS

FIG. 1 is a perspective view of an eddy current probe and delivery tubing consistent with implementations described herein;

FIG. 2A is a side view of a delivery tubing adapter consistent with implementations described herein; and

FIG. 2B is a side view of a portion of a length of delivery tubing consistent with an implementation described herein.

### DESCRIPTION OF THE PREFERRED EMBODIMENTS OF THE INVENTION

The following detailed description refers to the accompanying drawings. The same reference numbers in different drawings may identify the same or similar elements. Also, the following detailed description does not limit the invention.

Implementations described herein relate to non-destructive testing devices that include one or more testing coils for introducing an electromagnetic field into a tubular conduit under test. The non-destructive testing devices include a probe head coupled to a probe shaft. The shaft is coupled to a length of delivery tubing which is used to push or drive the probe head and probe shaft into the conduit under test or pull the probe head from the conduit. Consistent with implementations described herein, an adapter may be provided to securely couple the delivery tubing to the probe head. Consistent with implementations described herein, the adapter may include a delivery tubing engagement portion and a probe shaft engagement portion. The delivery tubing engagement portion includes a bard portion and a threaded portion for engaging an inside surface of the delivery tubing in a manner which minimizes the length of the adapter as well as the potential amount of adhesive used to secure the adapter to the delivery tubing during assembly. Such a configuration increases the flexibility of the delivery tubing interface which maintaining a high removal force.

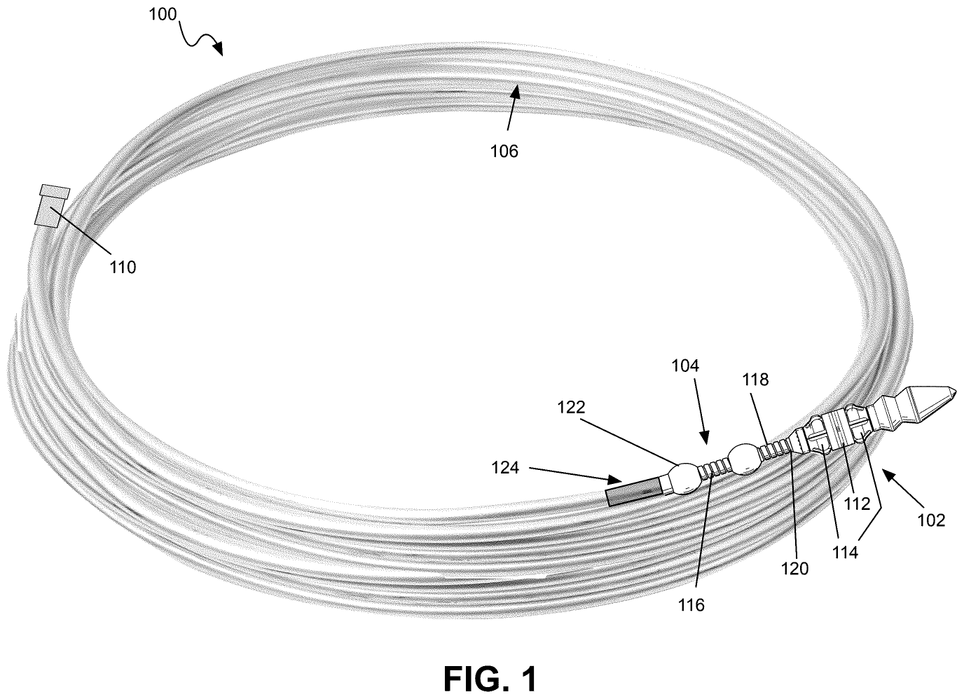

FIG. 1 is an isometric view of an eddy current probe system 100 consistent with implementations described herein. As shown, eddy current probe system 100 includes an eddy current probe head 102, a probe shaft 104, delivery tubing 106, a delivery tubing interface adapter 108, and a probe connector 110. Probe head 102 includes a probe body 112 containing at least one eddy current coil that projects and detects an alternating electromagnetic field within a tube under test. In some implementations, probe head 102 may include one or more centering members 114 for ensuring that probe body 112 is centered within the conduit under test. In some implementations, each probe centering member 114 includes a tubular or frustoconical base portion from which a plurality of resilient cantilevered legs project radially and distally outwardly therefrom and are coaxially spaced apart from the base portion, as shown in FIG. 1.

As shown, probe shaft 104 may include an extended flexible drive section 116, a rigid section 118 at its distal end 120 to which probe head 102 is attached, and a plurality of centering beads 122. The tubular base portion and the resilient cantilevered legs of the centering members 114 form a central aperture configured to engage probe body 104 and/or distal end 120 of probe shaft 104.

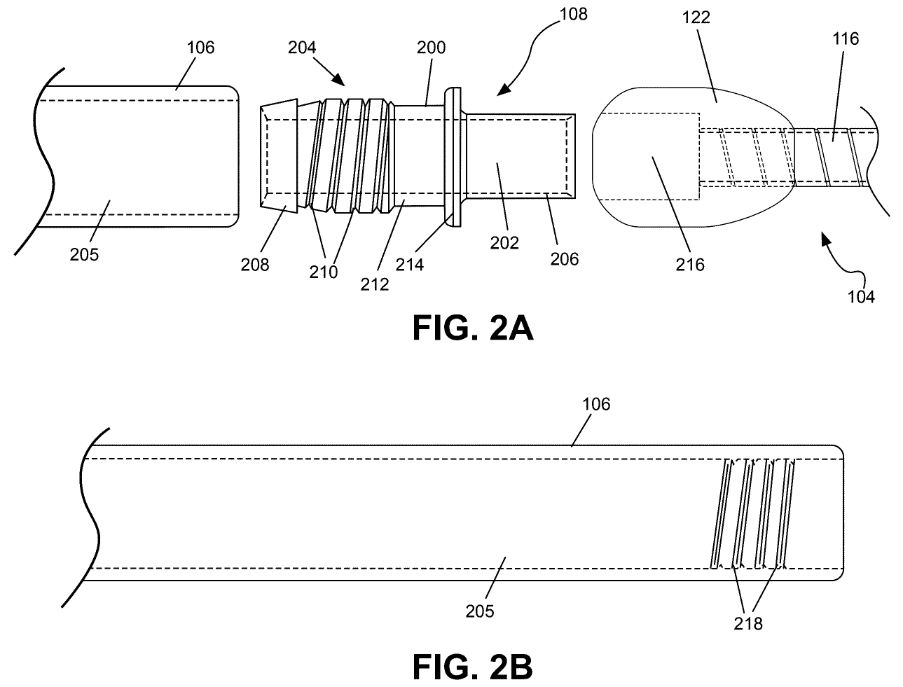

Consistent with implementations described herein, delivery tubing adapter 108 may be configured to securely engage each of the forward end of delivery tubing 106 and the rearward end of probe shaft 104. Details regarding implementations of delivery tubing adapter 108 are discussed below in relation to FIGS. 2A and 2B.

FIG. 2A is an exploded side view of delivery tubing adapter 108, a portion of delivery tubing 106, and a portion of probe head 102 consistent with implementations described herein. As shown in FIG. 2A, delivery tubing adapter 108 includes a generally tubular body 200 having a central aperture 202 extending therethrough configured to permit wiring to pass through delivery tubing 106 to probe head 102. In some implementations, delivery tubing adapter may be formed of a rigid material, such as stainless steel or the like to firmly engage portions of probe shaft 104 and delivery tubing 106.

Body 200 of delivery tubing adapter 108 includes a delivery tubing engagement portion 204 and a probe shaft engagement portion 206. Delivery tubing engagement portion 204 includes an outside diameter similar or slightly larger than an inside diameter of central aperture 205 such that the outside diameter of delivery tubing engagement portion 204 engages the inside surface of central aperture 205 in a frictional manner. Delivery tubing engagement portion 204 further includes two distinct securement elements, including a barbed portion 208 and a threaded portion 210.

As shown in FIG. 2A, barbed portion 208 includes one or more barbs configured to facilitate insertion of delivery tubing engagement portion 204 within central aperture 205 and to resist removal therefrom. Although barbed portion 208 is depicted in FIG. 2A as including one barb, any suitable number of barbs may be used, with the goal of optimizing removal force while simultaneously minimizing the overall length of delivery tubing adapter 108.

As shown in FIG. 2A, threaded portion 210 is configured to include a number of discrete threads which are configured to frictionally engage the inside surface of central aperture 205 of delivery tubing 106 and/or provide an increased surface area for engaging an adhesive (e.g., epoxy or the like) which may be employed to secure adapter 108 to delivery tubing 106 during assembly. Although four threads are shown in FIG. 2A, varying numbers of threads may be used based on the size of the probe and delivery tubing, and the environment into which the probe is to be used, with the goal of optimizing the required removal force while simultaneously minimizing the overall length of delivery tubing adapter 108.

Although delivery tubing 106 depicted in FIG. 2A includes central aperture 205 having a smooth interior surface, in other implementations, the interior surface of central aperture 205 may include a threaded portion 218 having configured to engage threaded portion 210 of delivery tubing adapter 108, as shown in FIG. 2B. Although FIG. 2B depicts a delivery tubing 106 having a similar number of threads as adapter 108, in some implementations, an entire interior surface of delivery tubing 106 may be threaded to accommodate threading of delivery tubing 106 onto adapter 108, irrespective of a cut length of delivery tubing 106.

In another implementation consistent with implementations described herein, threaded portion 218 on the interior surface of central aperture 205 may be formed oppositely from threaded portion 210 on adapter 108, so as to interfere with each other during assembly. In such an implementation, the threads in threaded portion 210 may actively cut through the threads in threaded portion 218 of the resilient material of delivery tubing 106 during manufacture/assembly to both provide an increased removal force requirement as well as additional surface area for adhesive engagement in implementations in which an adhesive is used in addition to the mechanical securement mechanisms described above.

As shown in FIG. 2A, delivery tubing engagement portion 204 may further include a forward portion 212 and flange 214. Forward portion 212 is positioned between threaded portion 210 and flange 214 and may include a reduced outside diameter relative to threaded portion 210. Such a reduced diameter provides an annular cavity about body 200 to receive any adhesive that may be employed during assembly. A length forward portion 212 is sized to provide an increased surface area for adhesive sufficient to optimize the required removal force while simultaneously minimizing the overall length of delivery tubing adapter 108. In some implementations, forward portion 212 may be entirely eliminated to further minimize the length of adapter 108. Flange 214 projects radially from body 200 and provides a forward stop against which delivery tubing 106 may abut during assembly. The outside diameter of flange 214 is substantially similar to the outside diameter of delivery tubing 106.

As shown in FIG. 2A, probe shaft engagement portion 206 projects forwardly from flange 214 and includes an outside diameter sized for receipt within an adapter aperture 216 in centering bead 122 of probe shaft 104. During assembly, probe shaft engaging portion 206 may be seated within adapter aperture 216 and secured via an adhesive, or other mechanical means, such as a friction fit, a threaded arrangement, etc.

The foregoing description of exemplary implementations provides illustration and description but is not intended to be exhaustive or to limit the embodiments described herein to the precise form disclosed. Modifications and variations are possible in light of the above teachings or may be acquired from practice of the embodiments. For example, variations to the dimensions of delivery tubing 106, the length and number of barbs in barbed portion 208, the dimensions of the threads in threaded portion 210, etc. may be made without departing from the improvements described herein.

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above-mentioned description is to be considered exemplary, rather than limiting, and the true scope of the invention is that defined in the following claims.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

What is claimed is:

1. An adapter for securely engaging an eddy current probe shaft to a length of delivery tubing, comprising:
a tubular body having a probe shaft engaging portion and a delivery tubing engaging portion,
wherein the probe shaft engaging portion is sized for receipt within a central aperture of the delivery tubing,
wherein the probe shaft engaging portion comprises at least a barbed portion and a threaded portion for frictionally engaging an inside surface of the delivery tubing.

2. The adapter of claim 1, wherein the barbed portion comprises at least one barb.

3. The adapter of claim 1, wherein the threaded portion comprises a number of discrete threads.

4. The adapter of claim 1, wherein the tubular body further comprises a flange that projects radially from the tubular body between the probe shaft engaging portion and a delivery tubing engaging, wherein an outside diameter of the flange is approximately equal to an outside diameter of the delivery tubing.

5. The adapter of claim 4, wherein the tubular body further comprises a forward portion between the threaded portion and the flange, wherein an outside diameter of the forward portion is less than an outside diameter of the threaded portion to form an annular cavity therearound to receive adhesive therein during assembly of the delivery tubing to the delivery tubing adapter.

6. An eddy current probe system, comprising:
a probe head;
a delivery tubing adapter; and
delivery tubing coupled to the probe head via the delivery tubing adapter for pushing or pulling the probe head into or out of a conduit under test,
wherein the delivery tubing adapter comprises:
a tubular body having a probe shaft engaging portion and a delivery tubing engaging portion,
wherein the probe shaft engaging portion is sized for receipt within a central aperture of the delivery tubing,
wherein the probe shaft engaging portion comprises at least a barbed portion and a threaded portion for frictionally engaging an inside surface of the delivery tubing.

7. The eddy current system of claim 6, wherein the barbed portion comprises at least one barb.

8. The eddy current system of claim 6, wherein the threaded portion comprises a number of discrete threads.

9. The eddy current system of claim 6, wherein the tubular body further comprises a flange that projects radially from the tubular body between the probe shaft engaging portion and a delivery tubing engaging, wherein an outside diameter of the flange is approximately equal to an outside diameter of the delivery tubing.

10. The eddy current system of claim 9, wherein the tubular body further comprises a forward portion between the threaded portion and the flange, wherein an outside diameter of the forward portion is less than an outside diameter of the threaded portion to form an annular cavity therearound to receive adhesive therein during assembly of the delivery tubing to the delivery tubing adapter.

11. The eddy current system of claim 6, wherein an interior surface of the delivery tubing includes a threaded portion configured to engage the threaded portion of the delivery tubing adapter.

12. The eddy current system of claim 11, wherein threaded portion on the interior surface of the delivery tubing includes an entirety of the interior surface of the delivery tubing.

13. The eddy current system of claim 11, wherein the threaded portion on the interior surface of the delivery tubing is formed oppositely from the threaded portion of the delivery tubing adapter.
